(19) United States
(12) Patent Application Publication
(10) Pub. No.: US 2025/0271296 A1
(43) Pub. Date: Aug. 28, 2025

(54) EVENT RECOGNITION APPARATUS, EVENT RECOGNITION METHOD, AND NON-TRANSITORY COMPUTER-READABLE MEDIUM

(71) Applicant: NEC Corporation, Tokyo (JP)

(72) Inventors: Noriyuki TONAMI, Tokyo (JP); Sakiko Mishima, Tokyo (JP); Yumi Arai, Tokyo (JP); Reishi Kondo, Tokyo (JP); Tomoyuki Hino, Tokyo (JP)

(73) Assignee: NEC Corporation, Tokyo (JP)

(21) Appl. No.: 19/052,504

(22) Filed: Feb. 13, 2025

(30) Foreign Application Priority Data
Feb. 28, 2024 (JP) 2024-028067

(51) Int. Cl. G01H 9/00

(52) U.S. Cl. CPC G01H 9/004

(57) ABSTRACT

A method includes: acquiring an observation signal indicating sound that occurs at a point along an optical fiber and is detected by optical fiber sensing; inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input; performing first processing of improving a SNR of an intermediate signal having a time-frequency structure acquired in an intermediate layer inside the deep learning model when the observation signal is input to the deep learning model; and acquiring the recognition result as an output of the deep learning model at a time when the observation signal is input, and outputting the acquired recognition result.

### INCORPORATION BY REFERENCE

This application is based upon and claims the benefit of priority from Japanese patent application No. 2024-028067, filed on Feb. 28, 2024, the disclosure of which is incorporated herein in its entirety by reference.

### TECHNICAL FIELD

The present disclosure relates to an event recognition apparatus, an event recognition method, and a non-transitory computer-readable medium.

### BACKGROUND ART

Optical fiber sensing, represented by distributed acoustic sensing (DAS), is capable of sensing sound and vibration that occur at a point along an optical fiber.

In recent years, a technique in which an observation signal indicating sound or vibration that occurs at a point along an optical fiber and is detected by optical fiber sensing is acquired, and an event (e.g., a vehicle is traveling, and the like) that occurs at the point along the optical fiber is recognized based on the acquired observation signal has been proposed.

Further, as a technique of recognizing an event, based on an observation signal acquired by optical fiber sensing, there is a technique of performing model learning on an observation signal, generating a deep learning model, and recognizing an event by using the generated deep learning model. For example, Published Japanese Translation of PCT International Publication for Patent Application, No. 2023-538196 discloses a technique of detecting a sound alarm pattern event by using a deep learning system.

### SUMMARY

Meanwhile, in a case where a deep learning model is used for optical fiber sensing, an observation signal acquired by the optical fiber sensing is required for model learning.

However, an observation signal acquired by the optical fiber sensing has a low signal-to-noise ratio (SNR) due to a large amount of optical noise (e.g., high-whiteness shot noise, quantum noise, or the like). Thus, since the number of observation signals effective for model learning is small in a first place, there is a problem that it is difficult to generate a deep learning model by performing model learning using the observation signal.

Thus, a technique that enables recognition of an event without performing model learning by using an observation signal acquired by optical fiber sensing is desired.

Therefore, in view of the problem described above, an object of the present disclosure is to provide an event recognition apparatus, an event recognition method, and a non-transitory computer-readable medium that are capable of recognizing an event without performing model learning by using an observation signal acquired by optical fiber sensing.

In a first example aspect, an event recognition apparatus includes:
at least one memory configured to store instructions; and
at least one processor configured to execute the instructions to:
   acquire an observation signal indicating sound that occurs at a point along an optical fiber and is detected by optical fiber sensing;
   input the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
   perform first processing of improving a signal-to-noise ratio of an intermediate signal having a time-frequency structure acquired in an intermediate layer inside the deep learning model when the observation signal is input to the deep learning model, with respect to the intermediate signal; and
   acquire the recognition result as an output of the deep learning model at a time when the observation signal is input, and output the acquired recognition result.

In a second example aspect, an event recognition method is
an event recognition method executed by an event recognition apparatus, including:
acquiring an observation signal indicating sound that occurs at a point along an optical fiber and is detected by optical fiber sensing;
inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
performing first processing of improving a signal-to-noise ratio of an intermediate signal having a time-frequency structure acquired in an intermediate layer inside the deep learning model when the observation signal is input to the deep learning model, with respect to the intermediate signal; and
acquiring the recognition result as an output of the deep learning model at a time when the observation signal is input, and outputting the acquired recognition result.

In a third example aspect, a non-transitory computer-readable medium is a non-transitory computer-readable medium storing a problem causing a computer to execute:
a procedure of acquiring an observation signal indicating sound that occurs at a point along an optical fiber and is detected by optical fiber sensing;
a procedure of inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
a procedure of performing first processing of improving a signal-to-noise ratio of an intermediate signal having a time-frequency structure acquired in an intermediate layer inside the deep learning model when the observation signal is input to the deep learning model, with respect to the intermediate signal; and
a procedure of acquiring the recognition result as an output of the deep learning model at a time when the observation signal is input, and outputting the acquired recognition result.

According to the above-described aspect, it is possible to provide an event recognition apparatus, an event recognition method, and a non-transitory computer-readable medium that are capable of recognizing an event without performing model learning by using an observation signal acquired by optical fiber sensing.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating an example of a method of acquiring a recognition result of an event by using a deep learning model learned by a sound signal acquired by a sound sensor;

FIG. 2 is a diagram illustrating an example of an intermediate signal having a time-frequency structure acquired in an intermediate layer inside the deep learning model when an observation signal acquired by optical fiber sensing is input to the deep learning model;

FIG. 3 is a diagram illustrating an example of processing of improving an SNR of the intermediate signal illustrated in FIG. 2;

FIG. 4 is a block diagram illustrating a schematic configuration example of an event recognition apparatus according to the present disclosure;

FIG. 5 is a flowchart illustrating an example of a flow of a schematic operation of the event recognition apparatus according to the present disclosure;

FIG. 6 is a diagram illustrating an example of a recognition result of an event by the event recognition apparatus according to the present disclosure, in comparison with a recognition result of an event by a related art;

FIG. 7 is a block diagram illustrating a schematic configuration example of the event recognition apparatus according to the present disclosure;

FIG. 8 is a diagram illustrating an example of an intermediate signal having a time-frequency structure acquired in an intermediate layer inside the deep learning model when a DAS observation signal is input to the deep learning model in the event recognition apparatus according to the present disclosure;

FIG. 9 is a diagram illustrating an example of an intermediate signal having a time-frequency structure acquired in an intermediate layer inside the deep learning model when a silent observation signal is input to the deep learning model in the event recognition apparatus according to the present disclosure;

FIG. 10 is a diagram illustrating an example of processing of improving the SNR of the intermediate signal illustrated in FIG. 8 in the event recognition apparatus according to the present disclosure;

FIG. 11 is a flowchart illustrating an example of a flow of a schematic operation of the event recognition apparatus according to the present disclosure;

FIG. 12 is a block diagram illustrating a schematic configuration example of the event recognition apparatus according to the present disclosure;

FIG. 13 is a flowchart illustrating an example of a flow of a schematic operation of the event recognition apparatus according to the present disclosure;

FIG. 14 is a block diagram illustrating a schematic configuration example of the event recognition apparatus according to the present disclosure; and

FIG. 15 is a block diagram illustrating a schematic hardware configuration example of a computer that achieves the event recognition apparatus according to the present disclosure.

### EXAMPLE EMBODIMENT

Hereinafter, example embodiments of the present disclosure will be described with reference to the drawings. Note that, the following description and the drawings are omitted and simplified as appropriate for clarity of description. Further, in each of the following drawings, the same elements are denoted by the same reference signs, and redundant descriptions are omitted as necessary. Furthermore, a specific numerical value and the like indicated below are merely examples for facilitating understanding of the present disclosure, and are not limited thereto.

### Overview of Each Example Embodiment

Before describing the details of each example embodiment of the present disclosure, an overview of each example embodiment will be described.

As described above, an observation signal acquired by optical fiber sensing has a low SNR due to a large amount of optical noise. Thus, since the number of observation signals effective for model learning is small in a first place, it is difficult to generate a deep learning model by performing model learning by using the observation signal.

In contrast, in recent years, a deep learning model learned by a sound signal acquired by a sound sensor such as a microphone has been distributed in the market.

Thus, by using a deep learning model that is distributed on the market and is learned by a sound signal acquired by a sound sensor, model learning using an observation signal acquired by optical fiber sensing becomes unnecessary.

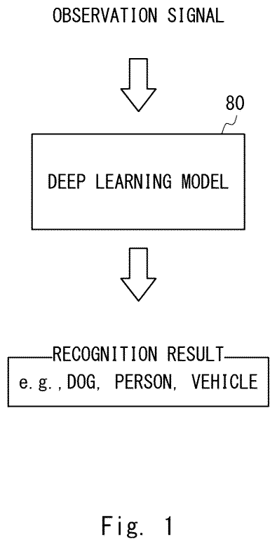

FIG. 1 is a diagram illustrating an example of a method of acquiring a recognition result of an event by using a deep learning model learned by a sound signal acquired by a sound sensor.

As illustrated in FIG. 1, a deep learning model 80 learned by a sound signal acquired by the sound sensor is prepared. The deep learning model 80 is a model in which an event occurring at a certain point is learned by using, as an input, a sound signal that indicates a sound occurred at the certain point and is acquired by the sound sensor.

In a case where a recognition result of an event occurred at a point along an optical fiber is acquired, an observation signal indicating a sound occurred at the point is input to the deep learning model 80. For example, the observation signal is a signal indicating sound such as a bark of a dog, a voice of a person, a traveling sound of a vehicle, and the like.

Then, as an output of the deep learning model 80, an event recognition result is acquired. For example, the event may be a dog barking, a person speaking, a vehicle traveling, and the like.

However, as described above, an observation signal acquired by optical fiber sensing has a low SNR due to a large amount of optical noise. In contrast, a sound signal acquired by a sound sensor such as a microphone does not include optical noise, and thus the SNR is high.

Thus, there is a gap in the SNR between the observation signal and the sound signal. Therefore, in a case where the observation signal is input to the deep learning model 80 learned by the sound signal, there is a concern that recognition performance of an event deteriorates due to the low SNR of the observation signal.

Thus, even in a case where the observation signal is input to the deep learning model 80, in order to improve the recognition performance of the event, it is necessary to fill the gap in the SNR between the observation signal and the sound signal.

Therefore, the present inventors and the like focus on an intermediate signal having a time-frequency structure acquired in an intermediate layer inside the deep learning model 80, and processing of improving the SNR with respect to the intermediate signal having the time-frequency structure is performed.

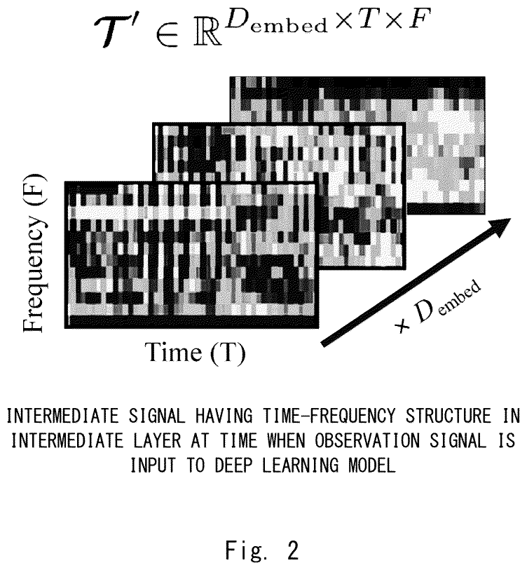

FIG. 2 is a diagram illustrating an example of an intermediate signal having the time-frequency structure acquired in the intermediate layer inside the deep learning model 80 when an observation signal acquired by optical fiber sensing is input to the deep learning model 80.

The intermediate signal illustrated in FIG. 2 is a signal in which a horizontal axis represents time and a vertical axis represents frequency, and a time change of a frequency component of the observation signal is indicated, that is, a signal having the time-frequency structure. In FIG. 2, a Dembed is the number of embedded dimensions of the intermediate layer inside the deep learning model 80. FIG. 2 illustrates an example that the Dembed is “3”.

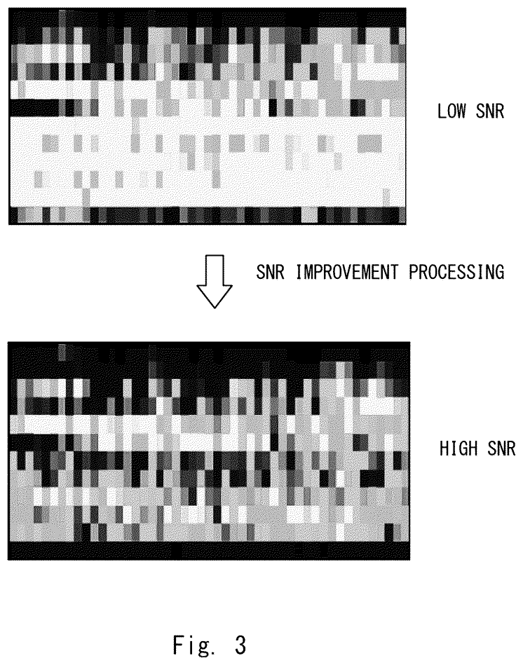

FIG. 3 is a diagram illustrating an example of SNR improvement processing of improving the SNR of the intermediate signal illustrated in FIG. 2.

As illustrated in FIG. 3, the SNR improvement processing of improving the SNR is performed on the intermediate signal having the time-frequency structure acquired in the intermediate layer inside the deep learning model 80. The SNR improvement processing is performed on each of the intermediate signals arranged in an embedding direction. Further, the SNR improvement processing may be noise suppression processing of suppressing noise of the intermediate signal, and the like.

As a result, a domain of the observation signal can be adapted to a domain of the sound signal, and thereby, the gap in the SNR between the observation signal and the sound signal can be filled. Thus, even in a case where the observation signal is input to the deep learning model 80, the recognition performance of the event can be improved.

Hereinafter, each example embodiment of the present disclosure will be described.

### First Example Embodiment

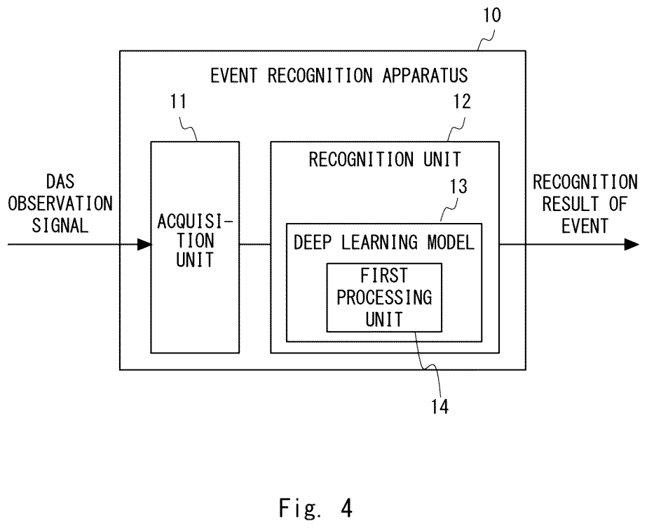

FIG. 4 is a block diagram illustrating a schematic configuration example of an event recognition apparatus 10.

As illustrated in FIG. 4, the event recognition apparatus 10 includes an acquisition unit 11 and a recognition unit 12.

The acquisition unit 11 acquires an observation signal indicating sound (e.g., a bark of a dog, a voice of a person, a traveling sound of a vehicle, and the like) that occurs at a point along an optical fiber and is detected by optical fiber sensing. In a first example embodiment, it is assumed that the acquisition unit 11 acquires a DAS observation signal from a DAS apparatus as an observation signal. For example, the DAS observation signal may be a time-domain signal R^{T} indicating a time change in intensity of a sound occurred at a point along an optical fiber. Alternatively, the DAS observation signal may be a frequency-domain signal C^{T×F} acquired by performing Fourier transform on the time-domain signal R^{T}.

The recognition unit 12 holds a deep learning model 13.

The deep learning model 13 is a model that is distributed in the market and is learned by a sound signal acquired by a sound sensor such as a microphone. Specifically, the deep learning model 13 is a model in which an event occurring at a certain point is learned by using, as an input, a sound signal that indicates a sound occurred at the certain point and is acquired by the sound sensor.

Further, the deep learning model 13 is a model that, when an input signal indicating sound occurred at a certain point is input to an input layer, outputs, from an output layer, a recognition result of an event occurred at the certain point. For example, the deep learning model 13 may output, as a recognition result of an event, an event such as a dog barking, a person speaking, or a vehicle traveling. Alternatively, the deep learning model 13 may output, as a recognition result of an event, a probability that at least one event is occurring at the point, and also output an event having a highest probability among the events.

The recognition unit 12 inputs the DAS observation signal acquired by the acquisition unit 11 to the deep learning model 13 as an input signal. Then, the recognition unit 12 acquires, as an output of the deep learning model 13, a recognition result of an event occurring at the point. Further, when the recognition result of the event is acquired, the recognition unit 12 outputs the recognition result to an outside of the event recognition apparatus 10.

Further, the recognition unit 12 includes a first processing unit 14.

The first processing unit 14 performs SNR improvement processing (see FIG. 3) of improving an SNR of an intermediate signal having a time-frequency structure (see FIG. 2) acquired in an intermediate layer inside the deep learning model 13 when the DAS observation signal is input to the deep learning model 13, with respect to the intermediate signal. For example, the SNR improvement processing may be noise suppression processing of suppressing noise of an intermediate signal. Further, for example, the noise suppression processing may be well-known noise suppression processing such as Wiener filtering, spectral subtraction, frequency filtering, and cepstrum analysis.

Subsequently, a schematic operation example of the event recognition apparatus 10 will be described.

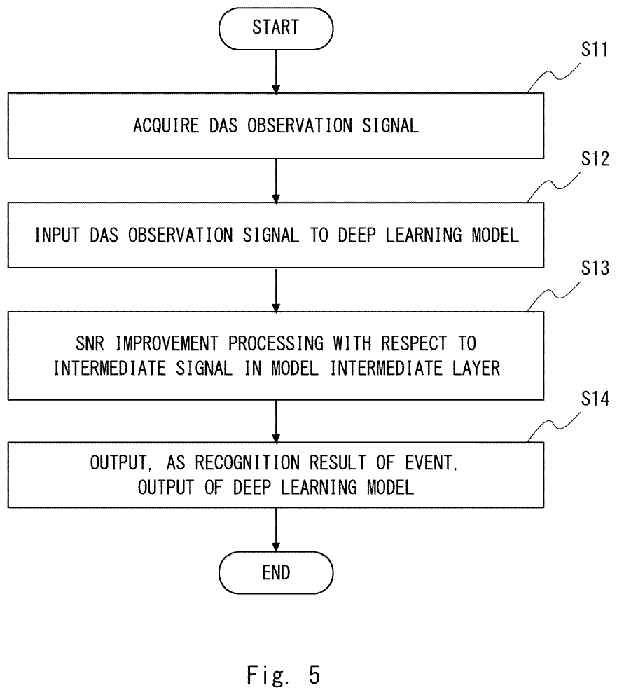

FIG. 5 is a flowchart illustrating an example of a flow of a schematic operation of the event recognition apparatus 10.

As illustrated in FIG. 5, the acquisition unit 11 acquires, from the DAS apparatus, a DAS observation signal indicating sound that occurs at a point along an optical fiber and is detected by optical fiber sensing (step S11).

Next, the recognition unit 12 inputs the DAS observation signal acquired by the acquisition unit 11 to the deep learning model 13 as an input signal (step S12).

Next, the first processing unit 14 performs SNR improvement processing of improving the SNR of an intermediate signal having the time-frequency structure acquired in the intermediate layer inside the deep learning model 13, with respect to the intermediate signal (step S13).

Thereafter, the recognition unit 12 acquires, as an output of the deep learning model 13, a recognition result of an event occurring at the above-described point, and outputs the acquired recognition result to an outside of the event recognition apparatus 10 (step S14).

Subsequently, a recognition result of an event by the event recognition apparatus 10 will be described.

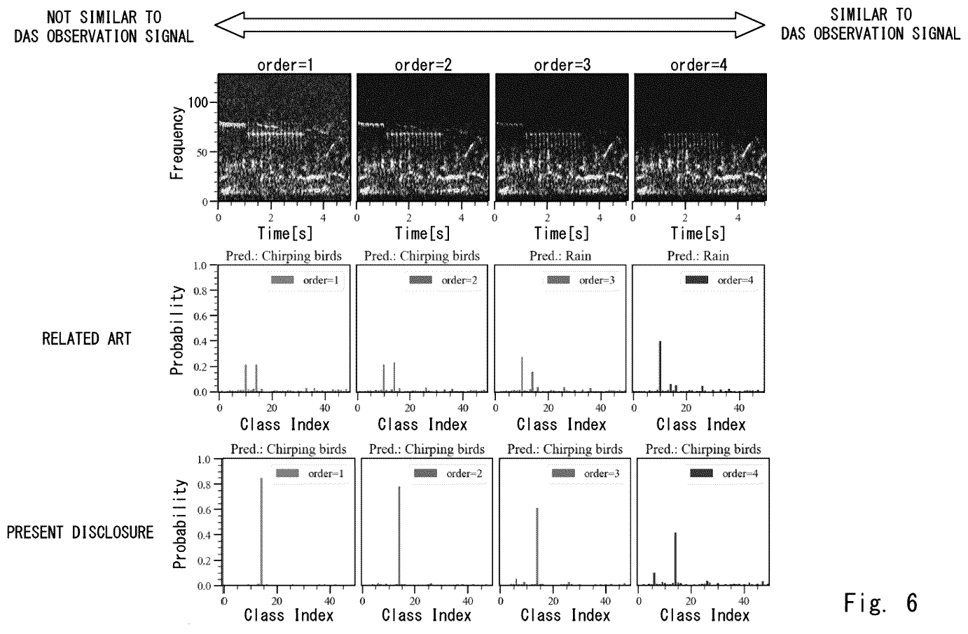

FIG. 6 is a diagram illustrating an example of a recognition result of an event by the event recognition apparatus 10, in comparison with a recognition result of an event by a related art.

Note that, an upper stage of FIG. 6 illustrates four simulated signals simulating a DAS observation signal indicating the same sound (herein, a chirp of a bird) occurred at the same point along an optical fiber. The four simulated signals are equivalent to the frequency-domain signal C^{T×F} described above, and a horizontal axis indicates time and a vertical axis indicates a frequency. Further, each of the four simulated signals becomes a signal similar to the DAS observation signal (i.e., a signal not similar to a sound signal acquired by the sound sensor) toward a right in the figure, and the SNR becomes lower. In other words, each of the four simulated signals becomes a signal not similar to the DAS observation signal (i.e., a signal similar to a sound signal) toward a left in the figure, and the SNR becomes higher.

Further, a middle stage of FIG. 6 illustrates a recognition result of an event in a case where each of the four simulated signals is input, as an input signal, to a deep learning model according to the related art. In the related art, after the input signal is input to the deep learning model, an output of the deep learning model is acquired as the recognition result of the event without performing the SNR improvement processing on an intermediate signal in an intermediate layer of the deep learning model.

Further, a lower stage of FIG. 6 illustrates a recognition result of an event in a case where each of the four simulated signals is input, as an input signal, to the deep learning model 13 of the event recognition apparatus 10 according to the present disclosure. As described above, in the event recognition apparatus 10, after the input signal is input to the deep learning model 13, an output of the deep learning model 13 is acquired as the recognition result of the event by performing the SNR improvement processing on the intermediate signal in the intermediate layer of the deep learning model 13.

Further, in each figure in the middle and lower stages of FIG. 6, the horizontal axis indicates an event class, and the vertical axis indicates a probability that an event of each event class has occurred. In this way, the deep learning model 13 according to the present disclosure in FIG. 6 outputs, as the recognition result of the event, the probability that the event of each event class has occurred at the point, and further outputs the event having the highest probability among the events. Further, the deep learning model according to the related art is similar thereto.

As illustrated in FIG. 6, in a case of two simulated signals on a left side in the figure that are not similar to the DAS observation signal and have the high SNR, the related art can recognize that the event is “chirping birds”. However, in a case of two simulated signals on a right side in the figure that are similar to the DAS observation signal and have the low SNR, the related art recognizes that the event is “rain”, and cannot recognize that the event is “chirping birds”.

In contrast, the event recognition apparatus 10 can recognize that the event is “chirping birds” for all four simulated signals. In this way, the event recognition apparatus 10 can improve recognition performance of an event.

As described above, according to the first example embodiment, the acquisition unit 11 acquires a DAS observation signal indicating sound that occurs at a point along an optical fiber and is detected by optical fiber sensing. The recognition unit 12 inputs the DAS observation signal, as an input signal, to the deep learning model 13 learned by using a sound signal acquired by a sound sensor. The first processing unit 14 performs SNR improvement processing of improving the SNR of an intermediate signal having a time-frequency structure acquired in an intermediate layer inside the deep learning model 13 when the DAS observation signal is input to the deep learning model 13, with respect to the intermediate signal. The recognition unit 12 acquires, as an output of the deep learning model 13, a recognition result of an event occurring at the above-described point, and outputs the acquired recognition result.

In this way, according to the first example embodiment, the deep learning model 13 learned by using a sound signal acquired by the sound sensor is used. This eliminates the need for model learning using the observation signal acquired by optical fiber sensing.

Further, according to the first example embodiment, the SNR improvement processing of improving the SNR of an intermediate signal having the time-frequency structure acquired in the intermediate layer inside the deep learning model 13 is performed on the intermediate signal. This can fill a gap in the SNR between the DAS observation signal and the sound signal. Therefore, even in a case where the DAS observation signal is input to the deep learning model 13, the recognition performance of an event can be improved.

### Second Example Embodiment

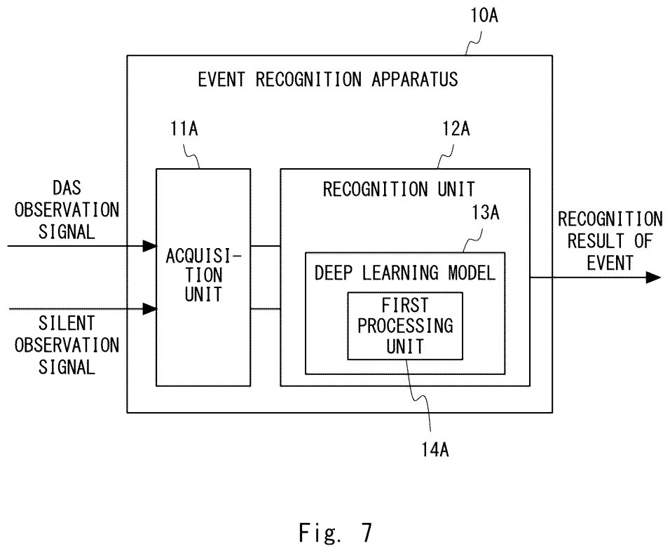

FIG. 7 is a block diagram illustrating a schematic configuration example of an event recognition apparatus 10A.

As illustrated in FIG. 7, the event recognition apparatus 10A includes an acquisition unit 11A and a recognition unit 12A.

The acquisition unit 11A acquires, from a DAS apparatus, a DAS observation signal indicating sound that occurs at a point along an optical fiber and is detected by optical fiber sensing.

In addition, the acquisition unit 11A acquires, from the DAS apparatus, a silent observation signal being a DAS observation signal at any point in a silent state.

Note that, it is assumed that the DAS observation signal in a second example embodiment is a signal at a time when some sound is generated at the above-described point, and is distinguished from the silent observation signal.

The recognition unit 12A holds a deep learning model 13A. The deep learning model 13A is similar to the deep learning model 13.

The recognition unit 12A inputs the DAS observation signal acquired by the acquisition unit 11A to the deep learning model 13A as an input signal. Further, the recognition unit 12A inputs the silent observation signal acquired by the acquisition unit 11A to the deep learning model 13A as an input signal. The silent observation signal is used in SNR improvement processing by a first processing unit 14A described later. Then, the recognition unit 12A acquires, as an output of the deep learning model 13A, a recognition result of an event occurring at the point, and outputs the acquired recognition result to an outside of the event recognition apparatus 10A.

Further, the recognition unit 12A includes the first processing unit 14A.

The first processing unit 14A performs SNR improvement processing on an intermediate signal having a time-frequency structure acquired in an intermediate layer inside the deep learning model 13A when the DAS observation signal is input to the deep learning model 13A, by using an intermediate signal having the time-frequency structure acquired in the intermediate layer inside the deep learning model 13A when the silent observation signal is input to the deep learning model 13A.

Herein, the SNR improvement processing performed by the first processing unit 14A will be described in detail.

As described above, in the second example embodiment, the DAS observation signal and the silent observation signal are input to the deep learning model 13A by the recognition unit 12A.

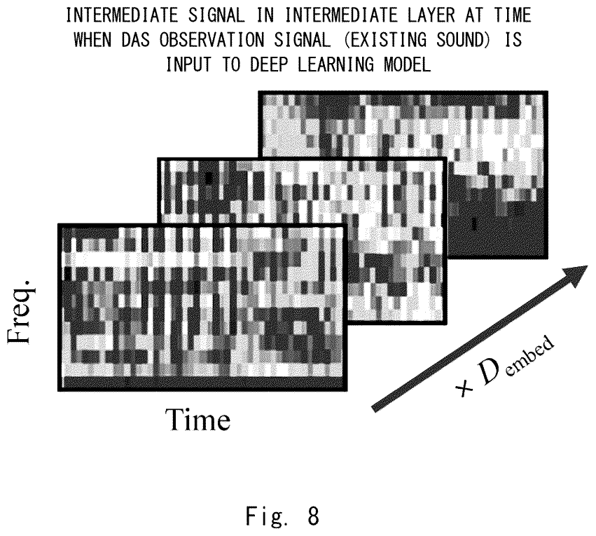

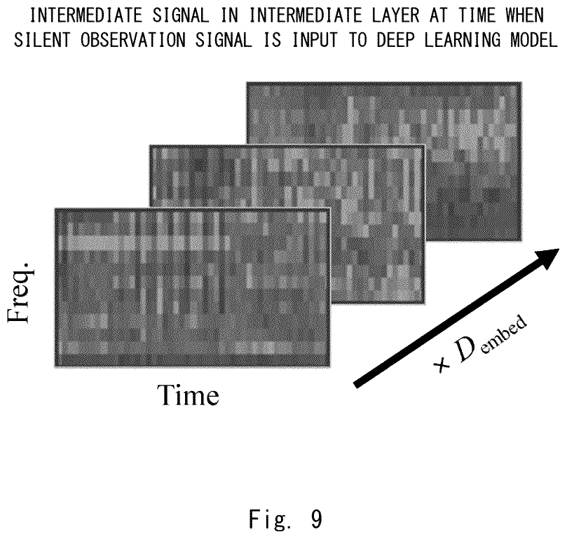

FIG. 8 is a diagram illustrating an example of an intermediate signal having the time-frequency structure acquired in the intermediate layer inside the deep learning model 13A when the DAS observation signal is input to the deep learning model 13A. Further, FIG. 9 is a diagram illustrating an example of an intermediate signal having the time-frequency structure acquired by the intermediate layer inside the deep learning model 13A when the silent observation signal is input to the deep learning model 13A.

Herein, a signal in a specific frequency band among intermediate signals at a time when the DAS observation signal is input includes a large amount of noise components. For example, in a case of the intermediate signal illustrated in FIG. 8, it is assumed that a large amount of noise components are included in a signal in a high frequency band.

Accordingly, the first processing unit 14A replaces a signal in the specific frequency band including a large amount of noise components among the intermediate signals at a time when the DAS observation signal is input, with a signal in the specific frequency band among the intermediate signals at a time when the silent observation signal is input.

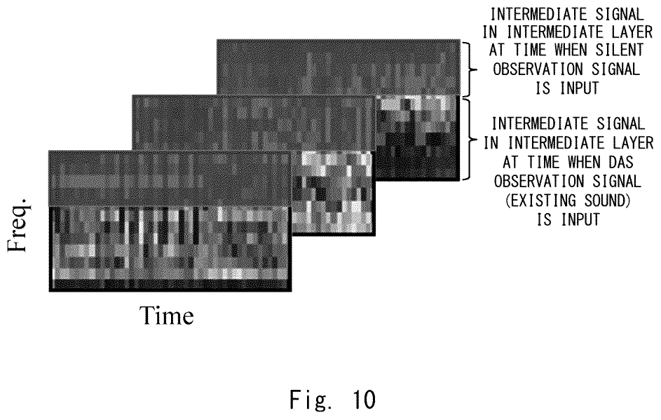

FIG. 10 is a diagram illustrating an example of the SNR improvement processing of improving the SNR of the intermediate signal illustrated in FIG. 8 in the first processing unit 14A.

As described above, it is assumed that the intermediate signal illustrated in FIG. 8 includes a large amount of noise components in the signal in the high frequency band. Therefore, the signal in the high frequency band among the intermediate signals illustrated in FIG. 8 becomes a signal in the specific frequency band to be replaced.

Accordingly, the first processing unit 14A replaces a signal in the specific frequency band (herein, the high frequency band) including a large amount of noise components among the intermediate signals illustrated in FIG. 8, with a signal in the specific frequency band among the intermediate signals illustrated in FIG. 9.

Note that, in the examples in FIGS. 8 to 10, the specific frequency band including a large amount of noise components is described as the high frequency band, but the present invention is not limited thereto. The specific frequency band including a large amount of noise components dynamically changes according to a point where an event is recognized and a situation (e.g., weather, a season, a time period, and the like) at the point, and may be a low frequency band or an intermediate frequency band between the high frequency band and the low frequency band. Thus, it is preferable that the specific frequency band is dynamically set in the first processing unit 14A according to a point where an event is recognized and a situation of the point. Note that, as a method of setting the specific frequency band in the first processing unit 14A, for example, a method performed manually by a user may be used.

Subsequently, a schematic operation example of the event recognition apparatus 10A will be described.

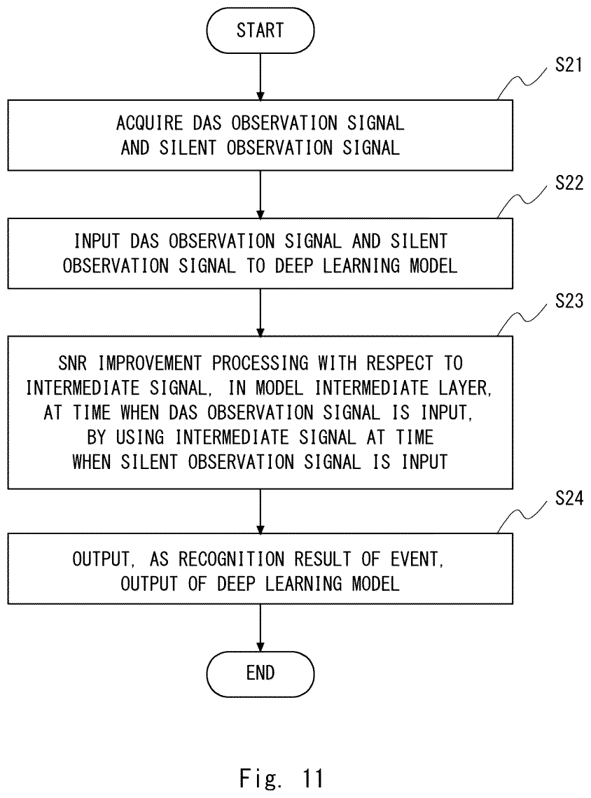

FIG. 11 is a flowchart illustrating an example of a flow of a schematic operation of the event recognition apparatus 10A.

As illustrated in FIG. 11, the acquisition unit 11A acquires, from the DAS apparatus, a DAS observation signal indicating sound that occurs at a point along an optical fiber and is detected by optical fiber sensing. Further, the acquisition unit 11A acquires, from the DAS apparatus, a silent observation signal being a DAS observation signal at any point in a silent state (step S21).

Next, the recognition unit 12A inputs the DAS observation signal and the silent observation signal acquired by the acquisition unit 11A to the deep learning model 13A as input signals (step S22).

Next, the first processing unit 14A performs the SNR improvement processing on an intermediate signal acquired in the intermediate layer when the DAS observation signal is input to the deep learning model 13A, by using an intermediate signal acquired in the intermediate layer when the silent observation signal is input to the deep learning model 13A (step S23).

Specifically, the first processing unit 14A replaces a signal in a specific frequency band including a large amount of noise components among the intermediate signals at a time when the DAS observation signal is input, with a signal of the specific frequency band among the intermediate signals at a time when the silent observation signal is input.

Thereafter, processing of step S24 similar to step S14 in FIG. 5 is performed.

As described above, according to the second example embodiment, the acquisition unit 11A acquires a DAS observation signal indicating sound that occurs at a point along an optical fiber and is detected by optical fiber sensing, and also acquires a silent observation signal at any point in a silent state. The recognition unit 12A inputs the DAS observation signal and the silent observation signal, as input signals, to the deep learning model 13A learned by using a sound signal acquired by a sound sensor. The first processing unit 14A performs the SNR improvement processing on an intermediate signal acquired in an intermediate layer when the DAS observation signal is input to the deep learning model 13A, by using an intermediate signal acquired in the intermediate layer when the silent observation signal is input to the deep learning model 13A.

Note that, other operations of the second example embodiment are similar to those of the first example embodiment described above.

In this way, in the second example embodiment, the operation related to the SNR improvement processing for the intermediate signal is different from that in the first example embodiment described above, but the other operations are similar to those in the first example embodiment described above.

Therefore, in the second example embodiment, an advantageous effect similar to that of the first example embodiment described above can be acquired.

### Third Example Embodiment

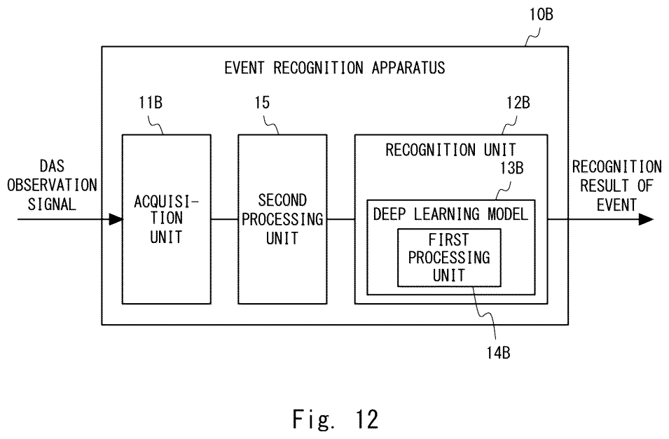

FIG. 12 is a block diagram illustrating a schematic configuration example of an event recognition apparatus 10B.

As illustrated in FIG. 12, the event recognition apparatus 10B includes an acquisition unit 11B, a second processing unit 15, and a recognition unit 12B.

The acquisition unit 11B is similar to the acquisition unit 11.

The second processing unit 15 performs SNR improvement processing of improving an SNR of a DAS observation signal acquired by the acquisition unit 11B, with respect to the DAS observation signal. For example, the SNR improvement processing may be noise suppression processing of suppressing noise of an intermediate signal. Further, for example, the noise suppression processing may be well-known noise suppression processing such as Wiener filtering, spectral subtraction, frequency filtering, and cepstrum analysis.

The recognition unit 12B holds a deep learning model 13B. The deep learning model 13B is similar to the deep learning model 13.

Further, the recognition unit 12B includes a first processing unit 14B. The first processing unit 14B is similar to the first processing unit 14.

The recognition unit 12B inputs the DAS observation signal whose SNR is improved by the second processing unit 15 to the deep learning model 13B as an input signal.

Other operations of the recognition unit 12B are similar to those of the recognition unit 12.

Subsequently, a schematic operation example of the event recognition apparatus 10B will be described.

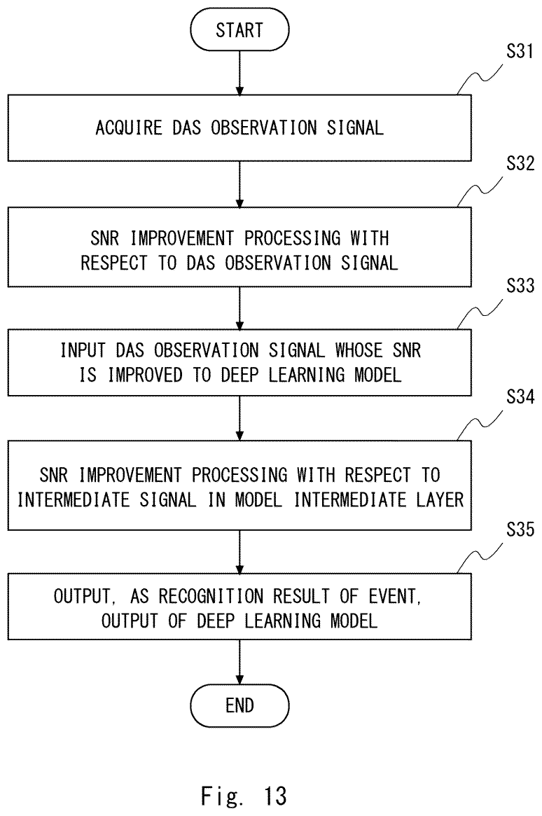

FIG. 13 is a flowchart illustrating an example of a flow of a schematic operation of the event recognition apparatus 10B.

As illustrated in FIG. 13, first, processing of step S31 similar to step S11 in FIG. 5 is performed.

Next, the second processing unit 15 performs the SNR improvement processing of improving the SNR of a DAS observation signal acquired by the acquisition unit 11B, with respect to the DAS observation signal (step S32).

Next, the recognition unit 12B inputs the DAS observation signal whose SNR is improved by the second processing unit 15 to the deep learning model 13B as an input signal (step S33).

Thereafter, pieces of processing of steps S34 and S35 similar to steps S13 and S14 in FIG. 5 is performed.

As described above, according to a third example embodiment, the second processing unit 15 performs the SNR improvement processing of improving the SNR of a DAS observation signal acquired by the acquisition unit 11B, with respect to the DAS observation signal. The recognition unit 12B inputs the DAS observation signal whose SNR is improved by the second processing unit 15 to the deep learning model 13B as an input signal.

Note that, other operations of the third example embodiment are similar to those of the first example embodiment described above.

In this way, according to the third example embodiment, as compared with the first example embodiment described above, an operation of performing the SNR improvement processing on the DAS observation signal and inputting the DAS observation signal whose SNR is improved to the deep learning model 13B is added. As a result, it is possible to further fill a gap in the SNR between the DAS observation signal and a sound signal, and thus it is possible to further improve recognition performance of an event in a case where the DAS observation signal is input to the deep learning model 13B.

Note that, another advantageous effect of the third example embodiment is similar to that of the first example embodiment described above.

### Fourth Example Embodiment

A fourth example embodiment is equivalent to an example embodiment in which the first to third example embodiments described above are put into a high-level concept.

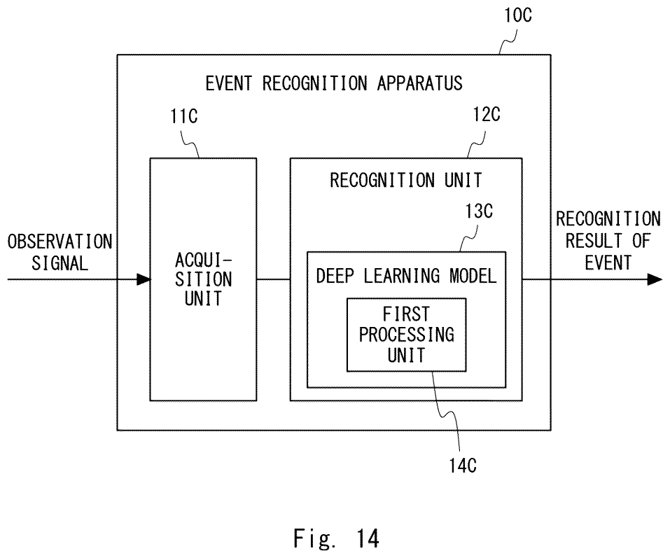

FIG. 14 is a block diagram illustrating a schematic configuration example of an event recognition apparatus 10C.

As illustrated in FIG. 14, the event recognition apparatus 10C includes an acquisition unit 11C and a recognition unit 12C.

The acquisition unit 11C acquires an observation signal indicating sound that occurs at a point along an optical fiber and is detected by optical fiber sensing.

The recognition unit 12C holds a deep learning model 13C.

The deep learning model 13C is a model learned by a sound signal acquired by a sound sensor, and is a model that outputs a recognition result of an event occurring at the above-described point, by using an input signal indicating a sound occurred at the above-described point as an input.

The recognition unit 12C inputs the observation signal acquired by the acquisition unit 11C to the deep learning model 13C as an input signal, acquires a recognition result of an event as an output of the deep learning model 13C, and outputs the acquired recognition result.

Further, the recognition unit 12C includes a first processing unit 14C.

The first processing unit 14C performs first processing of improving an SNR of an intermediate signal having a time-frequency structure acquired in an intermediate layer inside the deep learning model 13C when the observation signal is input to the deep learning model 13C, with respect to the intermediate signal.

In this way, according to the fourth example embodiment, the deep learning model 13C learned by using a sound signal acquired by a sound sensor is used. This eliminates the need for model learning using the observation signal acquired by optical fiber sensing.

Further, according to the fourth example embodiment, the first processing of improving the SNR of an intermediate signal having the time-frequency structure acquired in the intermediate layer inside the deep learning model 13C is performed on the intermediate signal. This can fill a gap in the SNR between the observation signal and the sound signal. Therefore, even in a case where the observation signal is input to the deep learning model 13C, recognition performance of an event can be improved.

Note that, the deep learning model 13C may be a model learned by a sound signal acquired by a microphone serving as a sound sensor.

Further, as the first processing, the first processing unit 14C may perform processing of suppressing noise of an intermediate signal, with respect to the intermediate signal.

Further, the acquisition unit 11C may further acquire a silent observation signal being an observation signal at any point in a silent state. Furthermore, the recognition unit 12C may further input the silent observation signal to the deep learning model 13C as an input signal. Moreover, as the first processing, the first processing unit 14C may perform processing of replacing a signal in a specific frequency band among intermediate signals acquired when the observation signal is input to the deep learning model 13C, with a signal in the specific frequency band among intermediate signals acquired when the silent observation signal is input to the deep learning model 13C.

Further, the event recognition apparatus 10C may further include a second processing unit that performs second processing of improving the SNR of an observation signal, with respect to the observation signal. Furthermore, the recognition unit 12C may input an observation signal whose SNR is improved by the second processing to the deep learning model 13C as an input signal. Moreover, the second processing unit may perform, as the second processing, processing of suppressing noise of an observation signal, with respect to the observation signal.

Further, the deep learning model 13C may be a model that outputs a probability in which at least one event is occurring at the above-described point, as a recognition result of the event.

Further, the acquisition unit 11C may acquire an observation signal from the DAS apparatus.

### Hardware Configuration of Event Recognition Apparatus

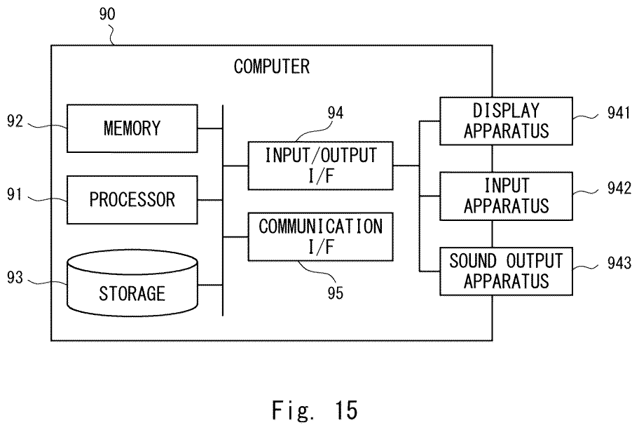

FIG. 15 is a block diagram illustrating a schematic hardware configuration example of a computer 90 that achieves the event recognition apparatuses 10, 10A, 10B, and 10C.

As illustrated in FIG. 15, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected to one another by a data transmission path for mutually transmitting and receiving data.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. Further, the storage 93 may be a memory such as a RAM or a ROM.

A program is stored in the storage 93. The program includes instructions (or software code) for causing the computer 90 to perform, in a case where loaded into the computer, one or more functions of the event recognition apparatuses 10, 10A, 10B, and 10C described above. A component of the event recognition apparatuses 10, 10A, 10B, and 10C described above may be achieved by the processor 91 reading and executing a program stored in the storage 93. Further, the above-described storage function of the event recognition apparatuses 10, 10A, 10B, and 10C may be achieved by the memory 92 or the storage 93.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus, such as a liquid crystal display (LCD), a cathode ray tube (CRT) display, or a monitor, that displays a screen relevant to rendering data processed by the processor 91. The input apparatus 942 is an apparatus that receives an operation input from an operator, and is, for example, a keyboard, a mouse, a touch sensor, or the like. The display apparatus 941 and the input apparatus 942 may be integrated and achieved as a touch panel. The sound output apparatus 943 is an apparatus, such as a speaker, that outputs sound relevant to sound data processed by the processor 91.

The communication interface 95 transmits and receives data to and from an external apparatus. For example, the communication interface 95 communicates with an external apparatus via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An event recognition apparatus including:
at least one memory configured to store instructions; and
at least one processor configured to execute the instructions to:
   acquire an observation signal indicating sound that occurs at a point along an optical fiber and is detected by optical fiber sensing;
   input the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
   perform first processing of improving a signal-to-noise ratio of an intermediate signal having a time-frequency structure acquired in an intermediate layer inside the deep learning model when the observation signal is input to the deep learning model, with respect to the intermediate signal; and
   acquire the recognition result as an output of the deep learning model at a time when the observation signal is input, and output the acquired recognition result.

### Supplementary Note 2

The event recognition apparatus according to supplementary note 1, wherein the deep learning model is a model learned by a sound signal acquired by a microphone serving as the sound sensor.

### Supplementary Note 3

The event recognition apparatus according to supplementary note 1, wherein the at least one processor is configured to execute the instructions to perform, as the first processing, processing of suppressing noise of the intermediate signal, with respect to the intermediate signal.

### Supplementary Note 4

The event recognition apparatus according to supplementary note 1, wherein the at least one processor is configured to execute the instructions to;
further acquire a silent observation signal being an observation signal at any point in a silent state;
further input the silent observation signal to the deep learning model as the input signal; and
perform processing of replacing a signal in a specific frequency band among the intermediate signals acquired when the observation signal is input to the deep learning model, with a signal of the specific frequency band among the intermediate signals acquired when the silent observation signal is input to the deep learning model.

### Supplementary Note 5

The event recognition apparatus according to supplementary note 1, wherein the at least one processor is configured to execute the instructions to;
perform second processing of improving a signal-to-noise ratio of the observation signal, with respect to the observation signal; and
input the observation signal whose signal-to-noise ratio is improved by the second processing to the deep learning model as the input signal.

### Supplementary Note 6

The event recognition apparatus according to supplementary note 5, wherein the at least one processor is configured to execute the instructions to perform, as the second processing, processing of suppressing noise of the observation signal, with respect to the observation signal.

### Supplementary Note 7

The event recognition apparatus according to supplementary note 1, wherein the deep learning model is a model that outputs, as the recognition result, a probability in which at least one event is occurring at the point.

### Supplementary Note 8

The event recognition apparatus according to supplementary note 1, wherein the at least one processor is configured to execute the instructions to acquire the observation signal from a distributed acoustic sensing (DAS) apparatus.

### Supplementary Note 9

An event recognition method executed by an event recognition apparatus, the event recognition method including:
acquiring an observation signal indicating sound that occurs at a point along an optical fiber and is detected by optical fiber sensing;
inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
performing first processing of improving a signal-to-noise ratio of an intermediate signal having a time-frequency structure acquired in an intermediate layer inside the deep learning model when the observation signal is input to the deep learning model, with respect to the intermediate signal; and
acquiring the recognition result as an output of the deep learning model at a time when the observation signal is input, and outputting the acquired recognition result.

### Supplementary Note 10

A non-transitory computer-readable medium storing a program causing a computer to execute:
a procedure of acquiring an observation signal indicating sound that occurs at a point along an optical fiber and is detected by optical fiber sensing;
a procedure of inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
a procedure of performing first processing of improving a signal-to-noise ratio of an intermediate signal having a time-frequency structure acquired in an intermediate layer inside the deep learning model when the observation signal is input to the deep learning model, with respect to the intermediate signal; and
a procedure of acquiring the recognition result as an output of the deep learning model at a time when the observation signal is input, and outputting the acquired recognition result.

Note that, some or all of elements (e.g., structures and functions) specified in Supplementary Notes 2 to 8 dependent on Supplementary Note 1 may also be dependent on Supplementary Note 9 and Supplementary Note 10 in dependency similar to that of Supplementary Notes 2 to 8 dependent on Supplementary Note 1. Some or all of elements specified in any of Supplementary Notes may be applied to various types of hardware, software, and recording means for recording software, systems, and methods.

What is claimed is:

1. An event recognition apparatus comprising:
at least one memory configured to store instructions; and
at least one processor configured to execute the instructions to:
acquire an observation signal indicating sound that occurs at a point along an optical fiber and is detected by optical fiber sensing;
input the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
perform first processing of improving a signal-to-noise ratio of an intermediate signal having a time-frequency structure acquired in an intermediate layer inside the deep learning model when the observation signal is input to the deep learning model, with respect to the intermediate signal; and
acquire the recognition result as an output of the deep learning model at a time when the observation signal is input, and output the acquired recognition result.

2. The event recognition apparatus according to claim 1, wherein the deep learning model is a model learned by a sound signal acquired by a microphone serving as the sound sensor.

3. The event recognition apparatus according to claim 1, wherein the at least one processor is configured to execute the instructions to perform, as the first processing, processing of suppressing noise of the intermediate signal, with respect to the intermediate signal.

4. The event recognition apparatus according to claim 1, wherein the at least one processor is configured to execute the instructions to;
further acquire a silent observation signal being an observation signal at any point in a silent state;
further input the silent observation signal to the deep learning model as the input signal; and
perform processing of replacing a signal in a specific frequency band among the intermediate signals acquired when the observation signal is input to the deep learning model, with a signal of the specific frequency band among the intermediate signals acquired when the silent observation signal is input to the deep learning model.

5. The event recognition apparatus according to claim 1, wherein the at least one processor is configured to execute the instructions to;
perform second processing of improving a signal-to-noise ratio of the observation signal, with respect to the observation signal; and
input the observation signal whose signal-to-noise ratio is improved by the second processing to the deep learning model as the input signal.

6. The event recognition apparatus according to claim 5, wherein the at least one processor is configured to execute the instructions to perform, as the second processing, processing of suppressing noise of the observation signal, with respect to the observation signal.

7. The event recognition apparatus according to claim 1, wherein the deep learning model is a model that outputs, as the recognition result, a probability in which at least one event is occurring at the point.

8. The event recognition apparatus according to claim 1, wherein the at least one processor is configured to execute the instructions to acquire the observation signal from a distributed acoustic sensing (DAS) apparatus.

9. An event recognition method executed by an event recognition apparatus, the event recognition method comprising:
acquiring an observation signal indicating sound that occurs at a point along an optical fiber and is detected by optical fiber sensing;
inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
performing first processing of improving a signal-to-noise ratio of an intermediate signal having a time-frequency structure acquired in an intermediate layer inside the deep learning model when the observation signal is input to the deep learning model, with respect to the intermediate signal; and
acquiring the recognition result as an output of the deep learning model at a time when the observation signal is input, and outputting the acquired recognition result.

10. A non-transitory computer-readable medium storing a program causing a computer to execute:
a procedure of acquiring an observation signal indicating sound that occurs at a point along an optical fiber and is detected by optical fiber sensing;
a procedure of inputting the observation signal, as an input signal, to a deep learning model, wherein the deep learning model is a model learned by a sound signal acquired by a sound sensor, and outputs a recognition result of an event occurring at the point, by using the input signal indicating sound being occurred at the point as an input;
a procedure of performing first processing of improving a signal-to-noise ratio of an intermediate signal having a time-frequency structure acquired in an intermediate layer inside the deep learning model when the observation signal is input to the deep learning model, with respect to the intermediate signal; and
a procedure of acquiring the recognition result as an output of the deep learning model at a time when the observation signal is input, and outputting the acquired recognition result.
